(19) United States
(12) Patent Application Publication
(10) Pub. No.: US 2023/0226583 A1
(43) Pub. Date: Jul. 20, 2023

(54) SYSTEM AND METHOD FOR ENVIRONMENTAL REMEDIATION

(71) Applicant: ECOSPEARS, INC., Altamonte Springs, FL (US)

(72) Inventors: Sergie A. Albino, Longwood, FL (US); Devon W. Miller, Altamonte Springs, FL (US)

(21) Appl. No.: 18/076,956

(22) Filed: Dec. 7, 2022

Related U.S. Application Data
(60) Provisional application No. 63/286,714, filed on Dec. 7, 2021.

(51) Int. Cl. B09C 1/00; B09C 1/08; C02F 1/26

(52) U.S. Cl. CPC B09C 1/002; B09C 1/08; C02F 1/26; B09C 2101/00; C02F 2101/363

(57) ABSTRACT

An environmental remediation system includes a contaminate treatment mat assembly to extract contaminates in pore water and sediment. The mat assembly includes a flexible liner and pore water and sediment-penetrating chambers individually anchored to the flexible liner. The anchored chambers include lids that are positioned above the liner and containers below the liner. The system includes a plate subsystem including plate holes. The plate subsystem is configured to have the mat assembly removable attached thereunder, absorb impact forces from a delivery system, translate the impact forces into a driving force applied simultaneously to tops of the lids of all the pore water and sediment-penetrating chambers under the plate subsystem to cause penetration of the containers into underlying pore water and sediment, and simultaneously displace fluid through liner holes of the liner and the plate holes. A method for environmental remediating using the system is also provided.

### CROSS-REFERENCE TO RELATED APPLICATIONS

This application claims priority benefit of U.S. Provisional Application No. 63/286,714, titled “SYSTEM AND METHOD FOR ENVIRONMENTAL REMEDIATION,” filed Dec. 7, 2021, which is incorporated herein in its entirety.

### BACKGROUND

Embodiments relate to contaminant remediation and, more particularly, to a system and method for environmental remediation to extract or desorb contaminants within pore water and sediment.

Waterways that are nearby landfills or other sites with hazardous water materials can become contaminated with polychlorinated biphenyl (PCBs). Levels of other water contaminates can vary based on geographical location. Common water contaminates include viruses, bacteria and microorganisms, for example. Some chemical compounds or chemicals naturally found in the environment can contaminate water such as aluminum (Al), fluoride, Arsenic (As) and nitrates (NO₃). Contaminates can also enter waterways from runoff after rain events, for example, environmental accidents or illegal dumping. Contaminants after reaching a waterway can settle in the pore water and sediment. Accordingly, there remains a need to remediate contaminants from waterways.

### SUMMARY

The embodiments herein relate to a system and methods for environmental remediation to extract or desorb polychlorinated biphenyl, dioxins, and other contaminants from pore water and sediment.

An aspect of the embodiments includes an environmental remediation system that includes a contaminate treatment mat assembly configured to extract contaminates in pore water and sediment. The mat assembly includes a flexible liner and pore water and sediment-penetrating chambers individually anchored to the flexible liner. The anchored chambers include lids that are positioned above the liner and containers anchored below the liner. The system includes a plate subsystem having plate holes. The plate subsystem is configured to have the mat assembly removable attached thereunder, receive impact forces from a delivery system, translate the received impact forces into a driving force applied simultaneously to tops of the lids of all the pore water and sediment-penetrating chambers under the plate subsystem to cause penetration of the containers into underlying the pore water and the sediment, and simultaneously displace fluid through liner holes of the liner and the plate holes.

The installation and removal (I&R) subsystem may include linear actuators to cause the rods to push or eject the mat assembly from the plate subsystem.

An aspect of the embodiments includes a method that extracts contaminants from pore water and sediment. The method includes installing an environmental remediation system in pore water and sediment. The method includes extracting contaminants solubilized with at least one solvent from the pore water and the sediment using the environmental remediation system embedded in the pore water and the sediment during a treatment period.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1A shows views of components of an environmental remediation system according to an embodiment coupled to a delivery system;

FIG. 1B shows views of components of the environmental remediation system of FIG. 1A;

FIG. 1C shows views of components of the environmental remediation system according to an embodiment coupled to a delivery system;

FIG. 2A shows a top view of the environmental remediation system and delivery system of FIG. 1A;

FIG. 2B shows a bottom view of the environmental remediation system of FIG. 1A;

FIGS. 3A, 3B and 3C show movement of the first plate member and push rods relative to the liner and the lids of the chambers for installation into pore water and sediment;

FIG. 4 shows a side view of a portion of a contaminate treatment mat assembly;

FIG. 5 shows a top view of a portion of a contaminate treatment mat assembly;

FIG. 6A shows views of components of an environmental remediation system according to an embodiment connected to portion of a delivery system;

FIG. 6B shows a top view of components of an environmental remediation system according to an embodiment of FIG. 6A;

FIG. 6C shows a bottom view of components of an environmental remediation system according to an embodiment of FIG. 6A; and

FIG. 7 shows views of components of an environmental remediation system according to an embodiment connected to a delivery system.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

The systems and methods of the disclosure provide a mechanism to extract or desorb polychlorinated biphenyl (PCB), dioxins and other contaminants from pore water and sediment of a waterway. The systems and methods are configured to line pore water and a sediment floor with a flexible liner used to also hold stake-like containers, which are configured to be anchored in the pore water and sediment and detached from a plate subsystem.

Contamination can be found in pore water when organics in sediments are saturated, for example. When system is deployed in this condition, the stake-like containers will generally first initially absorb contamination in pore water as it is easily more bioavailable. Once a disequilibrium is created, contamination from sediments will desorb and migrate to the pore water and then migrate to the plastic of the stake-like containers and then eventually into the solvent.

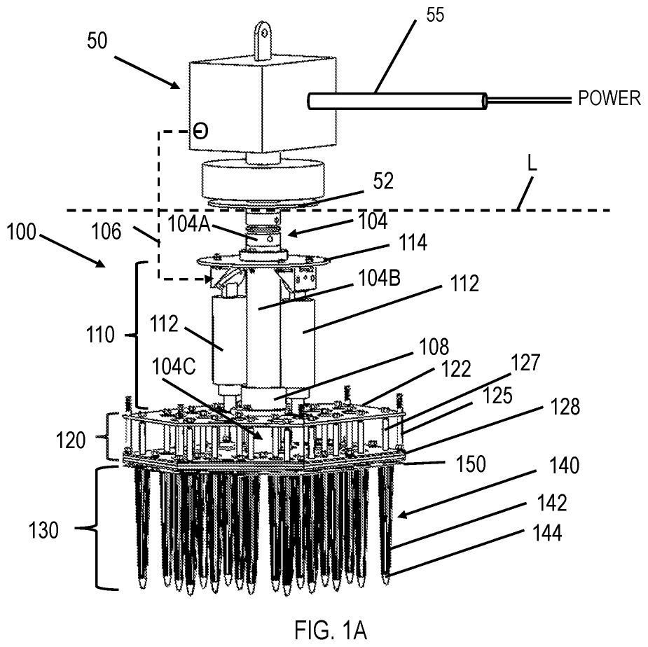

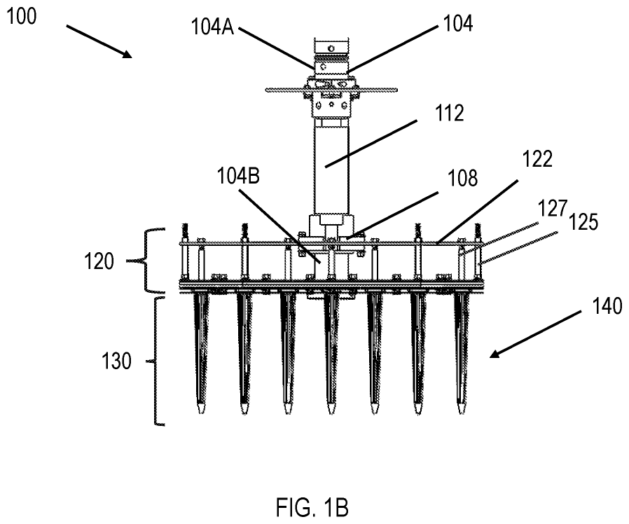

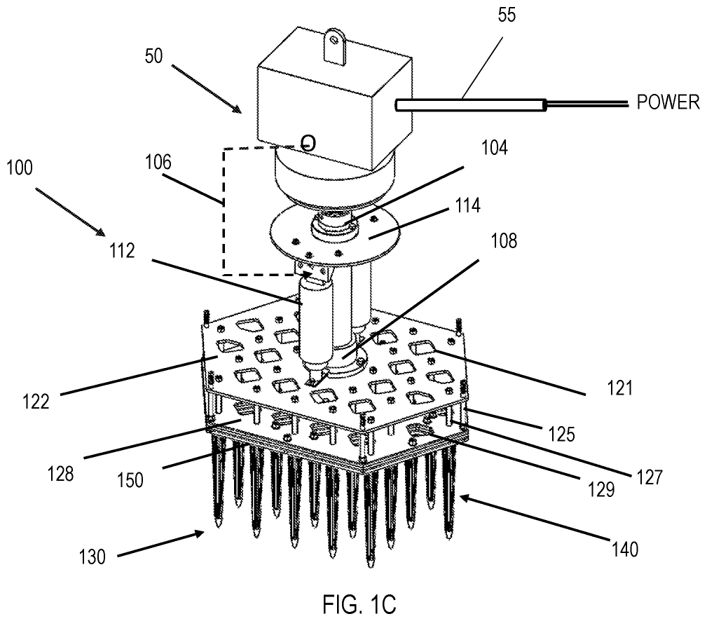

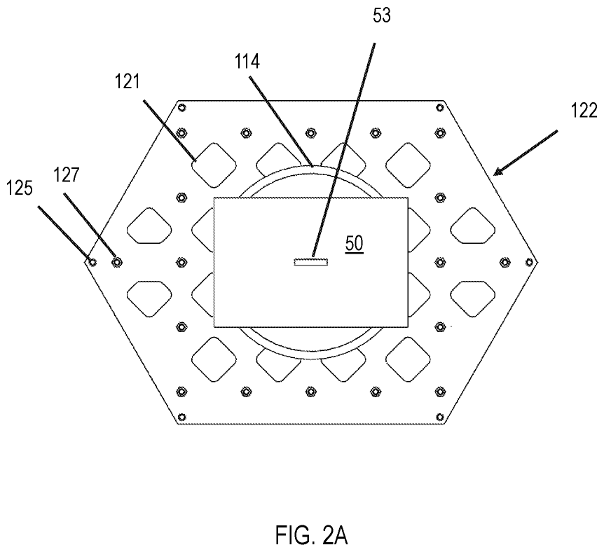

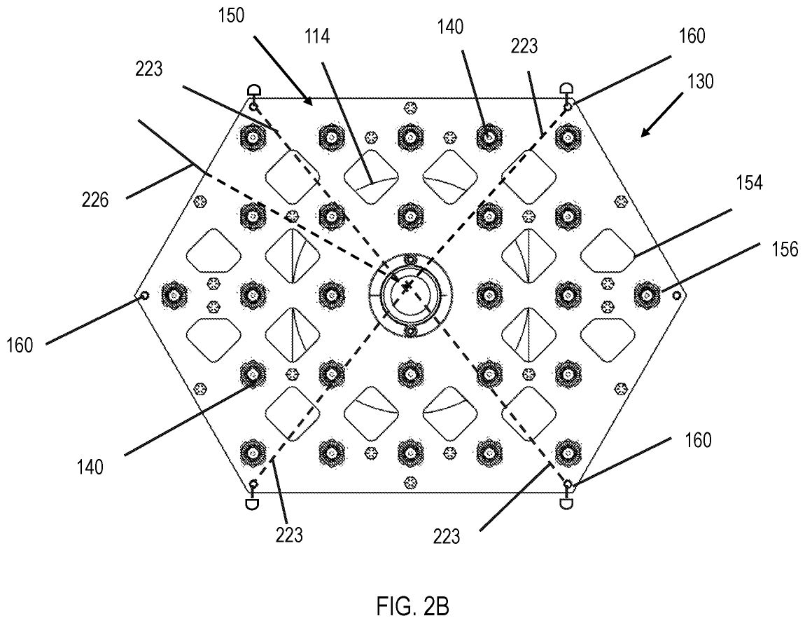

Referring to FIGS. 1A-1C, the components of the environmental remediation system 100 is shown. Specifically, FIGS. 1A and 1C show views of components of an environmental remediation system 100 connected to a delivery system 50. FIG. 1B shows views of components of the environmental remediation system of FIG. 1A. FIG. 2A shows a top view of the environmental remediation system and delivery system of FIG. 1A. FIG. 2B shows a bottom view of the environmental remediation system of FIG. 1A.

The environmental remediation system 100 may be attached to a delivery system 50. For example, the delivery system 50 may be a vibratory hammer or tripod, which is not part of this disclosure. The delivery system 50 may receive power via power cable 55. The delivery system 50 may be physically and electrically connected to the system 100, as will be described in more detail, via cable 106. The delivery system 50 may include components above dashed line denoted by the reference character L.

The system 100 may include an installation and removal (I&R) subsystem 110, a plate subsystem 120, and a contaminate treatment mat assembly 130. The contaminate treatment mat assembly 130 includes a flexible liner 150, which drapes over a contaminated area of pore water and sediment, and a plurality of chambers 140 independently anchored in the flexible liner 150. The flexible liner 150 drapes and flexes to conform to topology of the pore water and sediment. This improves the system's ability to install the chambers 140 as the topology of the pore water and sediment's floor changes. The chambers 140 include containers 142, which are dimensioned for pore water and sediment penetrating action. The chambers 142 may sometimes be referred to as pore water and sediment-penetrating chambers.

The mat assembly 130 effectuates environmental remediation by extracting polychlorinated biphenyl, dioxins, and other contaminants from an area of pore water and sediment by the chambers 140 embedded or anchored within the pore water and sediment.

The decontaminated pore water and sediment may include limited amounts of polychlorinated biphenyl, dioxins, and other contaminants that is below a requirements set by one of the Toxic Substance Control Act (TSCA), the Environmental Protection Agency (EPA), for example, or other acceptable levels.

The system 100 may include a center support 104, which is coupled to the contaminate treatment mat assembly 130, the plate subsystem 120 and the (I&R) subsystem 110. The plate subsystem 120 may include a first plate member 122 and a second plate member 128. The center support 104 is configured to be coupled to the delivery system 50.

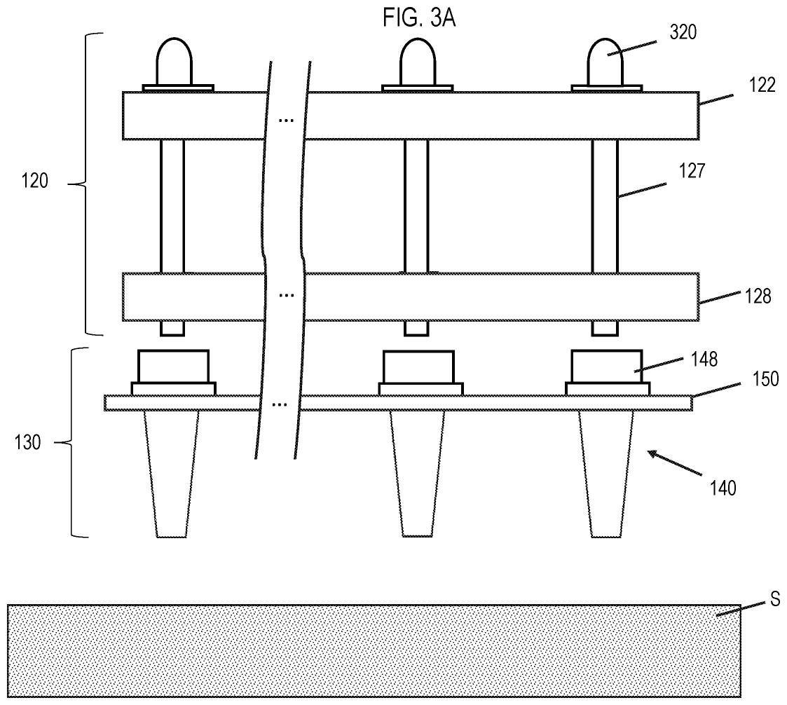

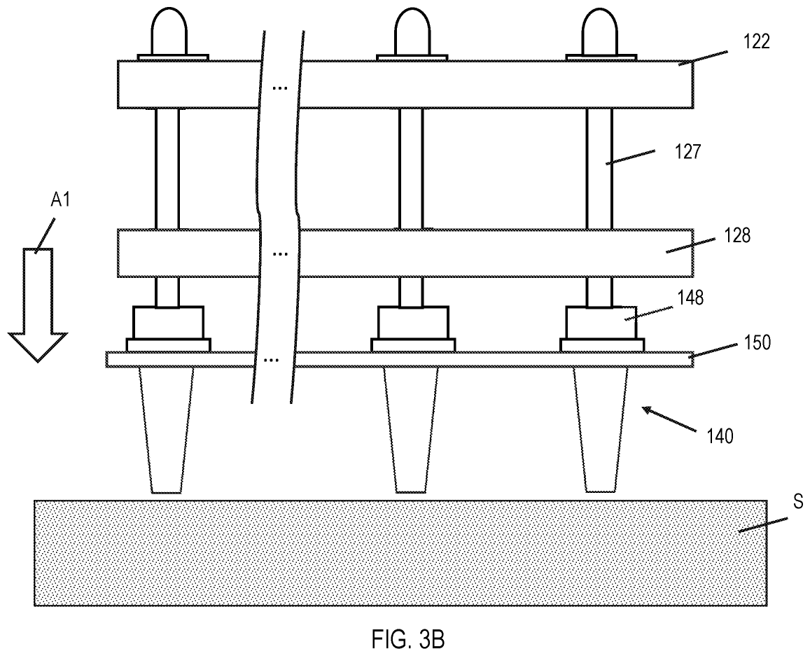

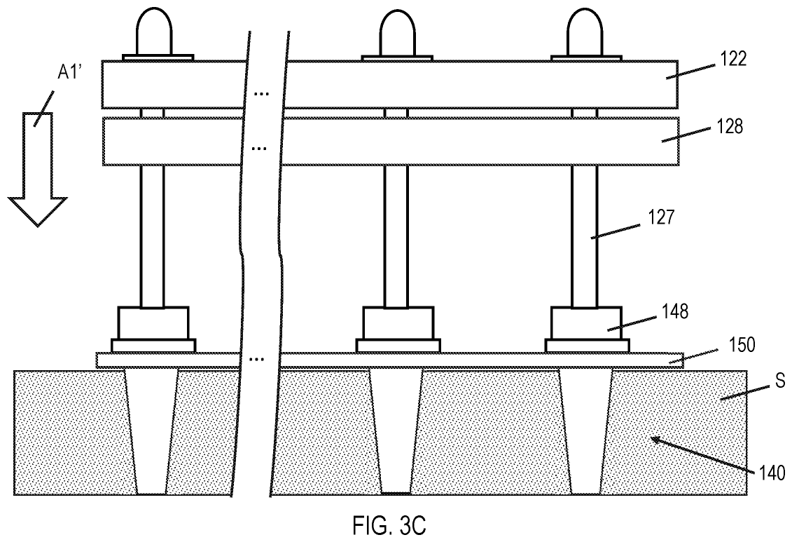

The delivery system 50 may include upper plate 52 which has mounted on one side of the components of the delivery system 50 and on the other side the center support 104. The delivery system 50 applies pressure to system 100 to submerge the system 100 underwater and position the bottom ends 144 of chambers 140 into position for penetration or anchoring into the pore water and sediment floor, as shown in FIGS. 3A-3C. The delivery system 50 and system 100 may be suspended by a hook or other fastener attached to a fastening mechanism 53 (FIG. 2A) on the top of the delivery system 50.

The center support 104 may include a top center support section 104A below upper plate 52 and above support plate 114. The center support 104 may include an intermediate center support section 104B coupled below the support plate 114 and to a first plate member 122. The support plate 114 has fastened thereto a first end of at least one linear actuator 112. A second end of the at least one linear actuator 112 is fastened to the first plate member 122. The first end and second end of the at least one linear actuator 112 are diametrically opposing. The center support 104 may include a lower center support section 104C below the first plate member 122 and coupled to the center of the second plate member 128. In operation, the first plate member 122 slides along a portion of the center support 104 in the direction of the second plate member 128. The center support 104 is coupled to the first plate member 122 via a mount 108 which allows the first plate member 122 to slide about the center support 104.

The flexible liner 150 may include a plurality of liner holes 154 and 156. At least some of the liner holes 156 are dimensioned to receive the container 142, but small enough to prevent the collar from passing through, as shown in FIGS. 3A-3C. The liner holes 154 permit water to pass through under the weight of the system or pressure/force exerted by the delivery system 50 and plate subsystem 120. In operation, the flexible liner 150 may be flexible so that it may flex or drape along the pore water and/or sediment floor and allow the containers 142 to be embedded in the sediment of an uneven sediment floor. The flexible liner 150 holds together the containers for installation in and subsequent removal from the pore water and sediment. The liner holes 154 may be aligned with and have the same shape as plate holes 121 and 129.

The contaminate treatment mat assembly 130 may include at least one solvent configured to absorb contaminates such as, without limitation, PCBs. For example, one or more of the walls of the containers 142 or chambers 140 may have a different solvent than other containers 142 or chambers 140. By way of non-limiting example, the solvent acts to allow the container 142 to absorb the PCBs, through the polymer walls and trap the PCBs within the container 142.

The liner 150 and/or container 142 may be made of a polymer that allows the uptake and transport of PCBs into and/or through a liner wall or container wall. The polymer allows for permeation of the PCB contaminants from the pore water and sediment and assist in removal (migration) of the PCBs from the pore water and sediment. The liner 150 and/or chambers 140 may be made of various amphiphilic (hydrophobic/hydrophilic ends) biodegradable polymers and co-polymers may be used based on their affinity and ability to transport PCB s across their matrix and into a hollow interior containing at least one solvent.

Additionally, liner 150 and/or chamber 140 may be made of polymers.

The mat assembly 130 may support 1-100 containers 142. The size of the flexible liner 150 is increased based on the number of chambers 140 mounted to the liner 150. The number of containers may be limited to the system's ability to separate the plate subsystem 120 from the mat assembly 130. For example, the system 100 may include 26 chambers 140 with containers 142. The mat assembly 130 is dimensioned to treat contaminates in an area of the pore water and sediment floor. In some embodiments, system 100 may include a plurality of mat assemblies 130 that may be deployed in a pattern in the pore water and over sediment floor and then later retrieved. For example, the flexible liner 150 may have a polygon shape may include, without limitation, octagons and hexagons. The plurality of mat assemblies 130 may be laid closely together in the pore water so that the sediment floor is essentially lined with flexible liners 150 and chambers 150 for remediation of environmental hazards, such as by way of non-limiting examples, polychlorinated biphenyls (PCBs) which are a family of chemical compounds. In other embodiments, the mat assemblies 130 may be spaced apart by a determined distance. The distance may be a function of the installation system so that an already installed mat assembly is not damaged, uninstalled or rendered inoperable.

In some embodiments, the mat assembly 130 is configured as a treatment system for removing halogenated compounds from contaminated sources, as described in U.S. Pat. No. 9,011,789 entitled “TREATMENT SYSTEM FOR REMOVING HALOGENATED COMPOUNDS FROM CONTAMINATED SOURCES,” incorporated herein by reference in its entirety. For example, a halogenated compound may permeate into or through a wall of the flexible liner 150 and/or container 142 where it is solubilized with at least one solvent received by the container 142. For example, the chambers 140 of the mat assembly 130 may be filled with or soaked until filled with at least one solvent configured to absorb PCBs or other contaminants, such as chlorinated pesticides, Chlordane, and dichlorodiphenyltrichloroethane (DDT). The lids of the chambers may also include at least one solvent.

The contaminant may be trapped in the pore water and sediment floor. The mat assemblies 130 may be installed on or over the pore water and sediment floor, generally, trapping the pore water and sediment of the treatment location as compared to an uncovered pore water and sediment floor.

The mat assemblies 130 are generally lightweight so that once installed in the pore water and sediment floor, the weight of the mat assembly does not further embed itself in the pore water and sediments from its own weight. As can be appreciated, pore water and sediment may collect on or under the flexible liner 150. However, the weight of the mat assembly 130 should be limited. The size of the mat assembly 130 may be selected so that its weight does not depress deep in the sediment.

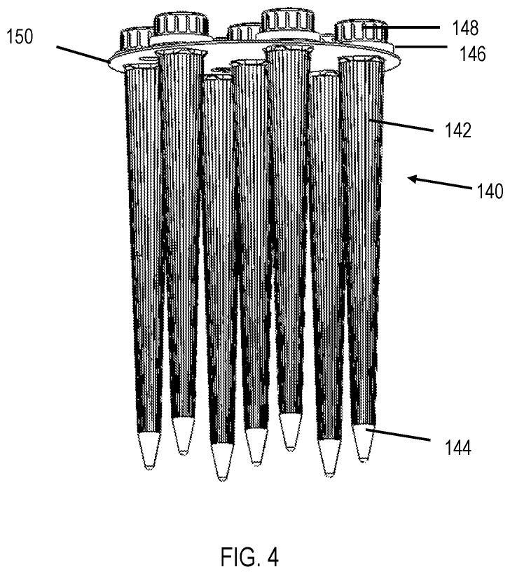

Returning again to FIGS. 1A-1C, the plate subsystem 120 may include guide rods 125 coupled to a first plate member 122 and a second plate member 128. The rods 127 push down on the removable lids 148 (FIG. 4) of containers 142 to release the mat assembly 130 from the plate subsystem 120 and anchor or penetrate the containers 142 into the pore water and/or sediment. In some embodiments, the rods 127 may act as hammer rods when driven by a vibratory hammer, for example. The rods 127 are distributed push rods 127 which provide a driving force directly to tops of the lids 148 of the chambers 140, as shown in FIGS. 3B-3C. The rods 127 are distributed into a pattern that coincides with the pattern of the chambers 140 anchored to the liner 150. Essentially, there is a one-to-one correspondence between the push rods 127 and the chambers 140. The guide rods 125 are affixed to second plate member 128. The push rods 127 are parallel to guide rods 125.

In operation, the push rods 127 push or hammer down on the top of the removable lids 148 in (FIG. 4) as the first plate member 122 moves downwards due to the motion or driving force exerted by the activated linear actuators 112 on the first plate member 122. The guide rods 125 act as guides for the first plate member 122 as it moves downwards during the penetration and anchoring of the containers 142 caused by the translated driving force.

The guide rods 125 allow the first plate member 122 to slide upward to generate the gap between the first plate member 122 and the second plate member 128 for the next installation process.

Each of the plate members 122 and 128 may include a plurality of first plate holes 121 and 129, respectively. These first plate holes allow water to pass through under the weight of the system or pressure/force exerted by the delivery system 50 and linear actuators 112. Additionally, the plate holes allow water to pass through and between the plate members as the plate members are forced together. The plate members 122 and 128 may include a plurality of second plate holes for connection of the guide rods 125. The plate members 122 and 128 may include a plurality of third plate holes for connection of the push rods 127. For example, push rods 127 slide within and out of the second plate member 128 but is affixed to the first plate member 122. The rods 125 are affixed to the second plate member 128 but slides within the first plate member 122.

The plate subsystem 120 includes distributed push rods 127. The push rods 127 are configured to be aligned with the pore water and sediment-penetrating chambers 140 of the mat assembly 130 when the mat assembly 130 is attached under the plate subsystem 120. Specifically, the mat assembly 130 is attached under the second plate member 128.

In operation, the plate subsystem 120 receives impact forces from a delivery system 50 and/or linear actuators 112, translate the received impact forces into a driving force applied simultaneously to tops of the lids 148 (FIG. 4) of all the pore water and sediment-penetrating chambers 140 under the plate subsystem 120 to cause penetration of the containers 142 into underlying pore water and sediment, and displace fluid through liner holes 154 (FIG. 2B) of the liner 150 and plate holes 121 and 129 of the plate subsystem 120. By way of non-limiting example, the plate subsystem 120 may translate the received impact forces by the delivery system 50 into a driving or hamming force applied by the distributed push (hammer) rods 127 simultaneously to tops of the lids 148 (FIG. 4). The linear actuators 112 are used to eject the mat assembly from the plate subsystem.

The guide rods 125 have a length. The first plate member 122 is coupled a first end of the guide rods. The second plate member 128 is parallel to the first plate member 122 and fastened to the second end of the guide rods 125. The first plate member and second plate member are separated from each other in a first state by the guide rods to form a gap, as shown in FIG. 1A. The first plate holes 121 and second plate holes 129 pass the fluid therethrough including fluid entering into the gap.

The I&R system 110 may include at least one linear actuator 112. In this example, the I&R subsystem 110 may include two or more linear actuators such as, without limitation, four linear actuators, which are synchronized. The linear actuators may be an electrical linear actuators. In operation, the at least one linear actuator 112 of the I&R subsystem 110 applies a force to the first plate member 122 to cause the first plate member to push the rods 127 through the second plate member 128 and into the flexible liner 150 to remove the mat assembly 130 from plate subsystem 120. Simultaneously, the holes 121 allow water to pass through the plate to displace the water from between the first plate member 122 and the second plate member 128. However, the driving system 50 produces the impact forces for driving the chambers into the pore water and sediment. The impact forces are vibratory hammer forces.

The I&R subsystem 110 may include a support plate 114 having a first end of the at least one linear actuator 112 coupled thereto. A second end of the at least one linear actuator 112 is connected to the plate member 122. In FIG. 1C, the plate member 122 is shown in a lifted state such that a gap is created between the first plate member 122 and the second plate member 128.

The plate members 122 and 128 are rigid and durable to absorb received impact forces from the delivery system 50, so that the plate members can be used over and over to embed or bury the containers 142 of the chambers 140 in the pore water and sediment floor.

Referring also to FIG. 2B, the system 100 may include cables 223, denoted in dashed lines, which may be attached to a single point and to holes 160 of the perimeter of liner 150. The cables 223 are shown in dashed lines because these cables should be on the top side of mat assembly 130. This single point via line 226 may be attached to an anchoring system (not shown). During retrieval, the anchoring system may be first pulled at the surface. Since the cables 223 are connected to the mat assembly 130, the cables 223 are also used to pull up the mat assembly 130 to the surface of the water.

FIGS. 3A, 3B and 3C show movement of the first plate member 122 and push rods 127 relative to the liner 150 and the lids 148 of the chambers 140 for installation into pore water and sediment. To prevent overcrowding in FIGS. 3A-3C, some of the components have been omitted. The linear actuators 112 (FIGS. 1A-1C) drive down plate 122 with multiple push rods 127 (hammers) that push the mat assembly 130 out from the plate member 128. Specifically, activation of the at least one linear actuator 112 pushes the first plate member 122 downward along the center support 104 and toward the second plate member 128 to eject the mat assembly. The impact forces from the driving system 50 causes the push rods to translate the received impact forces into the driving force simultaneously to tops of the lids of chamber 140. The guide rods 125 may be installed at locations around the perimeter of the first and second plate members 122 and 128.

The plate subsystem 120 and I&R subsystem 110 serve as an interface between the mat assembly 130 and delivery system 50, such as a vibratory hammer. The system and delivery system 50 are lowered by crane or winch from either a tripod or vessel into the water. The vibratory hammer and linear actuators 112 are energized and pushes at least a portion or all of the chambers 140 of the mat assembly 130 into the pore water and sediment.

FIG. 3A shows the first plate member 122 in a first position. The bottom of the rods 127 are shown above the lids 148 of chambers 140. The top end of the rods 127 are shown fastened via fastener 320 to the first plate member 122. The chambers 140 are shown anchored to the liner 150 such that the lid 148 of the chamber 140 is above the liner. The container 142 of the chamber 140 is moved through an aperture formed in liner such that the container or most of the container extends below the liner 150, which anchors, via the lid 148, the chamber 140 to the liner 150. In FIG. 3A, the ends of the chambers 140 are shown above pore water and sediment.

FIG. 3B shows an intermediate position of the first plate member 122 and push rods 127 relative to the liner 150 and the lids 148 of the chambers 140. While there are many intermediate positions, in this intermediate position the first plate member 122 has been lowered in the direction of arrow Al relative to the second plate member 128. The push rods 127 are affixed to the first plate member 122 and configured to slide through and out of the second plate member 128. The push rods 127 are touching the top of the lids 148. In FIG. 3B, the ends of the chambers 140 are shown just above pore water and sediment.

FIG. 3C shows a final position of the first plate member 122 and push rods 127 relative to the liner 150 and the lids 148 of the chambers 140. Here, the first plate member 122 has been lowered under pressure applied by the linear actuators 112 in the direction of arrow A1′ relative to the second plate member 128 to reduce the gap therebetween. The push rods 127 are affixed to the first plate member 122 and configured to slide further out through the second plate member 128 to move the mat assembly 130 away from the plate subsystem 120. The push rods 127 are still touching the top of the lids 148. In FIG. 3C, the ends of the chambers 140 and most of the containers 142 are shown anchored in or penetrating into the pore water and sediment. After the containers 142 are installed (anchored in or penetrating the pore water and sediment), the mat assembly 130 is ejected and removed from the remainder of the system 100 so that the remainder of the system can be reused to install the next mat assembly 130. The mat assembly 130 remains in place for a treatment period. Then, the mat assembly 130 may be removed from the pore water and sediment using cables 223 and line 226 for its return to the surface. The contents of the containers 142 may be subsequently treated or destroyed. The system 100 may be redeployed for further extraction or desorption of the contaminants in the pore water and sediment.

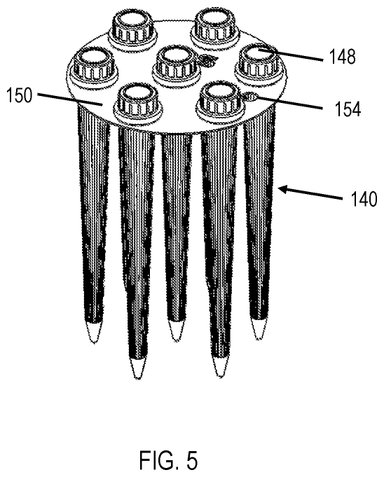

FIGS. 4 and 5 show partial views of the contaminate treatment mat assembly 130. The contaminate treatment mat assembly 130 may include a plurality of chambers 140 supported by a flexible liner 150. Each chamber 140 may include containers 142, which gradually taper. The container 142 includes a closed bottom end 144. The profile of the chambers 140 is configured to pierce or penetrate the pore water and sediment or waterway floor. The top of the chamber 140 may include a collar 146. The collar 146 may be used to support the chamber 140 above the liner 150. Each chamber 140 may include a removable lid 148. In some embodiments, the removable lid 148 may have a threaded connection to the chamber 140. In other embodiments, the removable lid 148 may have a snap on connection or other connections, which allow the lid 148 to be removed and reinstalled. An example chamber 140 is shown in U.S. Design Patent No. D900,277, titled “SPEAR WITH CAP,” issued Oct. 27, 2022, which is incorporated herein by reference.

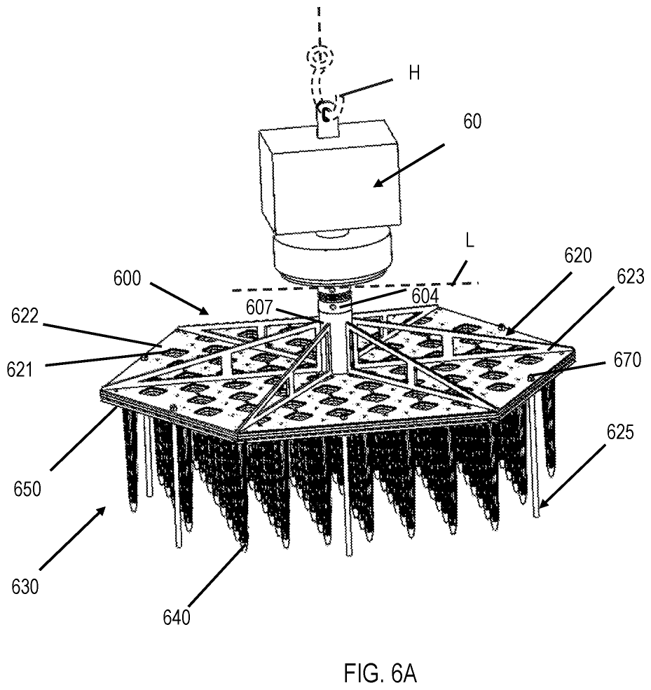

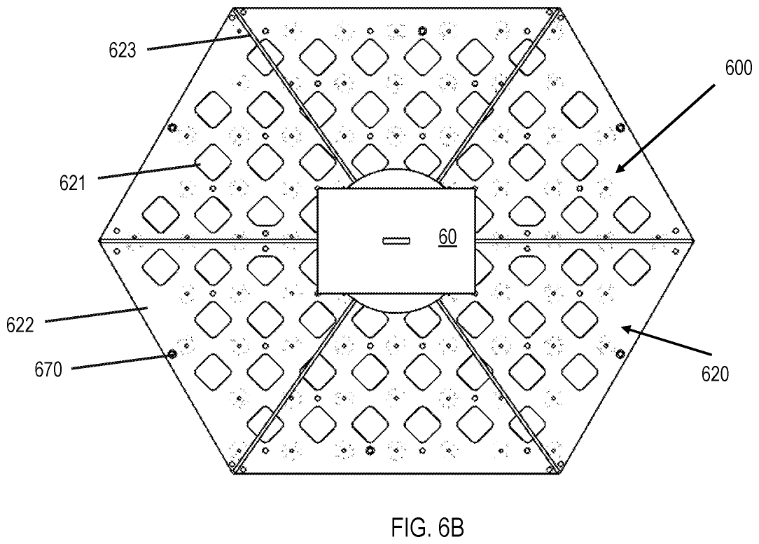

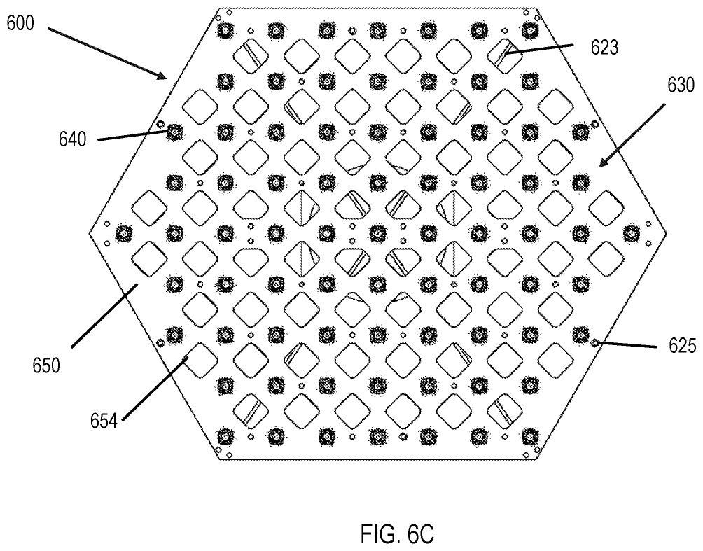

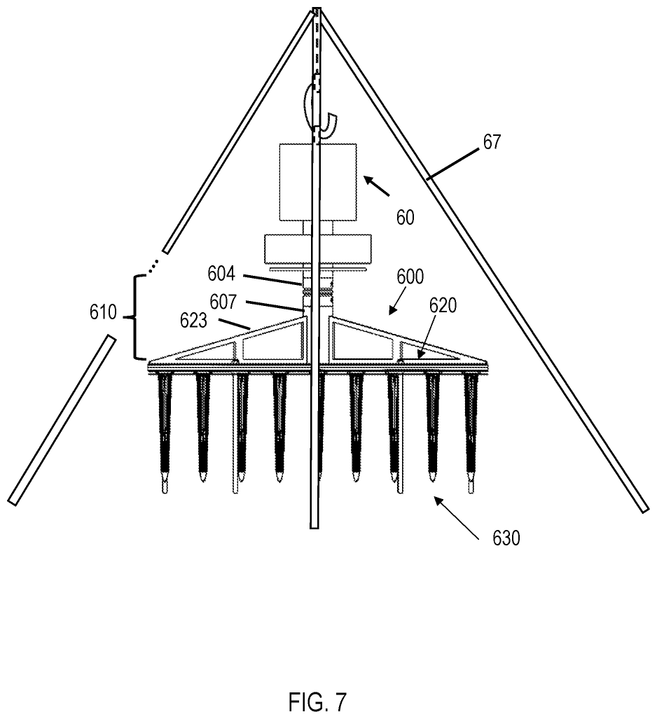

FIGS. 6A-6C and 7 show views of components of another environmental remediation system 600 according to an embodiment. FIG. 6A shows views of components of an environmental remediation system 600 according to an embodiment and connected to portion of a delivery system 60. The delivery system 60 is shown coupled to hook H shown in phantom. The components below the dashed line L denote the environmental remediation system 600. FIG. 6B shows a top view of components of an environmental remediation system 600 according to an embodiment of FIG. 6A. FIG. 6C shows a bottom view of components of an environmental remediation system 600 according to an embodiment of FIG. 6A. FIG. 7 shows views of components of an environmental remediation system 600 according to an embodiment connected to a delivery system 60 with a tripod 67 for installation into the pore water and sediment.

In FIG. 6A, the mat assembly 630 may be configured to fit into the plate 650 via a friction fit. In this embodiments, the mat assembly is not ejected using a linear actuator.

The systems 100 and 600 are similar. Therefore, only the differences will be described. The delivery system 60 may connect to a tripod 67. In FIG. 7, a portion of one of the tripod legs is removed to prevent overcrowding in the figure. In the embodiment of FIGS. 6A, 6C and 7, the number of the chambers 640 (i.e., chambers 140) is approximately 75. While the shape is an octagon, a hexagon or triangle may also be used to closely align each flexible liner 650 in the pore water and along sediment floor. Additionally, the system 100 or 600 may be configured with any number of chambers 140 or 640. However, in some embodiments, the systems may have 100 or less chambers. The plate subsystem 620 may include connectors 670 to connect rods 625 to the plate member 622 and/or flexible liner 650. The connectors 670 are to be removed to separate the mat assembly 630 and the rods 625 from the plate subsystem 620, after installation. In some embodiments, the connectors 670 may be reinstalled on the tops of the rods 625 so that the rods 625 remain attached to the liner 150 of the mat assembly 130 during the treatment period. The rods 625 remain anchored or penetrated within the pore water and sediment along with the chambers 640. In the illustration, the connectors 670 and rods 625 are coupled in a center or midpoint of a side of the polygon. However, the connectors 670 and rods 625 may be placed at corners of the polygon. Nonetheless, in an embodiment where the plate subsystem 620 includes two parallel plate members, the corners may also include guide rods (i.e., guide rods 125) coupled to the two plate members, as described above in relation to system 100.

The same plate subsystem 620 may be used for installation of the other mat assemblies to cover an area of the pore water and sediment floor. The plate subsystem 620 may include a first plate member 622 having plate supports 623 on top thereof. The supports 623 may be triangularly shaped trusses, for example, and distribute the driving force applied to the plate subsystem 620 from the delivery system 60. The supports 623 are coupled to a sleeve 607. The sleeve 607 is configured to slide along the center support 604 along with the first plate member 622. In this configuration, activation of delivery system 60 causes the plate subsystem 620 to apply impact forces to the mat assembly 630.

The system 600 may include an installation and removal (I&R) subsystem 610. The I&R subsystem 610 may include a center support 604, a sleeve 607 and trusses (i.e., supports 623) coupled to the plate subsystem 620 and the sleeve 607.

The plate subsystem 620 may receive impact forces from a delivery system 60 and translates the received impact forces into a driving force simultaneously applied to tops of the lids of all the pore water and sediment-penetrating chambers under the plate subsystem to cause penetration of the containers into underlying pore water and sediment. The plate subsystem 620 simultaneously displaces fluid moving through the holes 654 of liner 650 and the holes 621 of the plate subsystem 620.

To prevent overcrowding, the mat assembly 630 may include cables (i.e., cables 223) and a line (i.e., line 226), as shown in FIG. 2B, to lift the mat assembly 630 after the treatment period, for example.

In some embodiments, the plate subsystem 620 may include one or two plate members (i.e., plate members 122 and 128) similar to the plate subsystem 120 of FIG. 1A. In this embodiments, the plate subsystem 620 is described with a single plate member 622.

The method steps described herein may be performed in the order described or a different order. One or more steps may be performed contemporaneously. One or more steps may be added or deleted.

The method of treating contaminates may include using the system 100 of FIGS. 1A-1C, 2A and 2B and delivering the system 100 in the pore water and to the sediment floor of a treatment area using a delivery system 50. The preparation (preparing) of the at least one mat assembly 130 may include installing or anchoring the treated chambers 140 into the flexible liner 150. The preparation (preparing) of the at least one mat assembly 130 may include affixing the cables 223 with line 226 to the flexible liner.

The preparation (preparing) of the at least one mat assembly 130 may include treating the pore water and sediment-penetrating chambers 140 with at least one solvent, prior to treatment period or installation of the system.

The method may include installing a mat assembly 130 of the at least one mat assembly 130 under the plate subsystem 120.

The method may include delivering the system 100 to pore water and a sediment site to be treated under water.

The method may include, by the plate subsystem 120, receiving impact forces from a delivery system, translating the received impact forces into a driving force applied simultaneously to tops of the lids 148 of all the pore water and sediment-penetrating chambers 140 under the plate subsystem 120 to cause penetration of the containers 142 into underlying pore water and sediment, and simultaneously displacing fluid through liner holes of the liner 150 and the plate holes 121, 129 of the plate subsystem 120.

The translating of the driving force may include driving down multiple push rods 127 that push or hammer the lids of the mat assembly 130 from under the second plate member 128.

The method may include during a treatment period, desorbing or extracting, by the chambers 140, the contaminants such as polychlorinated biphenyl, dioxins, or other contaminants from pore water and sediment.

After the treatment period, the mat assembly 130 may be lifted up to the surface. The method may include testing the contents of filled in the containers 142 for contaminant levels.

The method may be repeated until the contaminant levels are acceptable.

A method includes extracting the contaminants using an environmental remediation system of FIGS. 1A-1C, 2A, 2B, 3A-3C, 6A-6C and 7 during a treatment period.

The method may further include treating, a contaminate treatment mat assembly of the system with at least one solvent to cause the contaminants to be desorbed during the treatment period.

The method may include installing a plurality of mat assemblies, each configured to be individually removably attached to and under a plate subsystem of the system.

The installation (installing) of the method may include draping a flexible liner of respective one mat assembly over pore water and a sediment floor and flexing the flexible liner to conform to a topology of the pore water and/or sediment floor. Since the liner is flexible, the draping and flexing are autonomous.

The method may include installing a plate subsystem of the system using an installation and removal (I&R) subsystem that includes a center support and at least one linear actuator coupled to the plate subsystem; and during the installing applying an impact force by the at least one linear actuator to the plate subsystem to cause the plate subsystem to slide along the center support and eject the mat assembly from the plate subsystem.

The method may include passing fluid passing through the plate holes of the first plate member and the second plate member including the fluid entering in the gap.

The method may include activating the at least one linear actuator to push the first plate member towards the second plate member and to reduce the gap; and by the driving system, causing the push rods to translate the impact forces into the driving force simultaneously to hammer on tops of the lids of all the pore water and sediment-penetrating chambers.

The method may include treating contaminants that may include polychlorinated biphenyl and dioxins, after removal of the mat assembly from the pore water and sediment.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

What is claimed is:

1. An environmental remediation system comprising:
a contaminate treatment mat assembly configured to extract contaminates in pore water and sediment and includes a flexible liner and pore water and sediment-penetrating chambers individually anchored to the flexible liner, the anchored chambers include lids that are positioned above the liner and containers anchored below the liner; and
a plate subsystem including plate holes and being configured to:
have the mat assembly removable attached thereunder,
receive impact forces from a delivery system,
translate the received impact forces into a driving force applied simultaneously to tops of the lids of all the pore water and sediment-penetrating chambers under the plate subsystem to cause penetration of the containers into underlying the pore water and the sediment, and
simultaneously displace fluid through liner holes of the liner and the plate holes.

2. The environmental remediation system according to claim 1, wherein the contaminate treatment mat assembly is treated with at least one solvent to absorb the contaminants.

3. The environmental remediation system according to claim 1, wherein the pore water and sediment-penetrating chambers are treated with the at least one solvent.

4. The environmental remediation system according to claim 1, further comprising a plurality of mat assemblies, each configured to be individually removably attached to and under the plate subsystem.

5. The environmental remediation system according to claim 1, wherein the flexible liner drapes over a sediment floor and flexes to conform to a topology of the sediment floor.

6. The environmental remediation system according to claim 1, further comprising:
an installation and removal (I&R) subsystem includes a center support and at least one linear actuator coupled to the plate subsystem, the at least one linear actuator to eject the mat assembly from the plate subsystem.

7. The environmental remediation system according to claim 6, wherein:
the plate subsystem further comprises:
guide rods,
a first plate member having the plate holes, and
a second plate member parallel to the first plate member and having the plate holes;
the first plate member and second plate member are separated from each other in a first state by the guide rods to form a gap between the first plate member and the second plate member; and
the plate holes of the first plate member and the second plate member pass the fluid passing therethrough including the fluid entering in the gap.

8. The environmental remediation system according to claim 7, wherein the plate subsystem further comprises:
push rods coupled to the plate subsystem, the push rods are aligned with tops of the lids of all the pore water and sediment-penetrating chambers,
wherein activation of the at least one linear actuator pushes the first plate member towards the second plate member to reduce the gap and the delivery system causes the push rods to translate the impact forces into the driving force simultaneously to hammer on tops of the lids to anchor the pore water and sediment-penetrating chamber in the pore water and the sediment.

9. The environmental remediation system according to claim 1, further comprising:
an installation and removal (I&R) subsystem includes a center support, a sleeve and trusses coupled to the plate subsystem and the sleeve.

10. The environmental remediation system according to claim 9, further comprising:
rods removably coupled to the plate subsystem and coupled to the liner of the mat assembly; and
connectors to removably fasten the rods to the plate subsystem,
wherein removing the connectors allows the rods to be removed from the plate subsystem.

11. A method comprising:
installing an environmental remediation system of claim 1, in pore water and sediment; and
extracting contaminants solubilized with at least one solvent from the pore water and the sediment using the environmental remediation system embedded in the pore water and the sediment during a treatment period.

12. The method according to claim 11, further comprising:
prior to extracting the contaminants, treating a contaminate treatment mat assembly of the system with at least one solvent to absorb the contaminants during the treatment period.

13. The method according to claim 12, further comprising installing a plurality of mat assemblies, each configured to be individually removably attached to and under a plate subsystem of the system.

14. The method according to claim 14, wherein the installing the plurality of mat assemblies includes draping a flexible liner of respective one mat assembly over a sediment floor and flexing the flexible liner to conform to a topology of the sediment floor.

15. The method according to claim 12, further comprising:
installing a plate subsystem of the system using an installation and removal (I&R) subsystem that includes a center support and at least one linear actuator coupled to the plate subsystem; and
during the installing of the plate subsystem, ejecting, by the at least one linear actuator, the mat assembly from the plate subsystem.

16. The method according to claim 16, wherein:
the plate subsystem further comprises:
guide rods,
a first plate member having the plate holes, and
a second plate member parallel to the first plate member and having the plate holes;
the first plate member and second plate member are separated from each other in a first state by the guide rods to form a gap between the first plate member and the second plate member; and
the method further comprises:
passing fluid passing through the plate holes of the first plate member and the second plate member including the fluid entering in the gap.

17. The method according to claim 17, wherein the plate subsystem further comprises:
push rods coupled to the plate subsystem, the push rods are aligned with tops of the lids of all the pore water and sediment-penetrating chambers, and
the method further comprises:
pushing the first plate member towards the second plate member and to reduce the gap; and
causing the push rods to translate the impact forces into the driving force simultaneously to hammer on tops of the lids of all the pore water and sediment-penetrating chambers into the pore water and the sediment.

18. The method according to claim 17, wherein the impact forces are a vibratory hammer forces.

19. The method according to claim 11, wherein the contaminants include polychlorinated biphenyl and dioxins.
